(19) United States
(12) Patent Application Publication
(10) Pub. No.: US 2006/0105764 A1
(43) Pub. Date: May 18, 2006

(54) Adaptive wireless networks and methods for communicating multimedia in a proactive enterprise

(76) Inventors: Dilip Krishnaswamy, Roseville, CA (US); John Vicente, Roseville, CA (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/989,539

(22) Filed: Nov. 16, 2004

(51) Int. Cl. H04Q 7/20

(52) U.S. Cl. 455/424

(57) ABSTRACT

In a wireless network, wireless communication devices include a distributed network information base (DNIB) to store network information and a service agent to communicate the network information directly between non-adjacent layers of a protocol stack. The service agents utilize the network information to at least maintain or enhance performance of currently active application layer applications as network conditions change. In some embodiments, the service agents may help optimize multimedia performance as network conditions change, and may dynamically respond to changes in link quality.

### TECHNICAL FIELD

Embodiments of the present invention pertain to wireless networks.

### BACKGROUND

The communication of interactive multimedia over wireless networks generally requires high bandwidth due to the data rates and payload size. One wireless scenario has users conducting real-time, multimedia videoconferencing sessions over a wide-area wireless Internet connection. The wireless client may be highly mobile within an enterprise campus or dense city limits and may be sharing a media-rich presentation with multiple parties, dispersed in different connectivity scenarios (e.g., home, hotel, or corporate office). For the user to experience a high degree of quality-of-service supporting the multimedia session and presentation delivery, regardless of his movement or locality, the effects of time-varying channel conditions as well as local or remote congestion conditions should be considered.

Thus, what is needed are methods and wireless networks that dynamically adapt to the effects of time-varying channel conditions as well as local or remote congestion conditions to support multimedia communication.

### BRIEF DESCRIPTION OF THE DRAWINGS

FIG. 1 illustrates a wireless network in accordance with some embodiments of the present invention;

FIG. 2 is a block diagram of a wireless communication device in accordance with some embodiments of the present invention;

FIG. 3 is a flow chart of a service agent operating procedure in accordance with some embodiments of the present invention;

FIG. 4 is a flow chart of a distributed network information base update procedure in accordance with some embodiments of the present invention;

FIG. 5 is a flow chart of an alternate service path reconfiguration procedure in accordance with some embodiments of the present invention;

FIG. 6 is a flow chart of a system-wide optimization procedure in accordance with some embodiments of the present invention; and

FIG. 7 illustrates the operations of a distributed network information base (DNIB) service agent (SA) in accordance with some embodiments of the present invention.

### DETAILED DESCRIPTION

The following description and the drawings illustrate specific embodiments of the invention sufficiently to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. Embodiments of the invention set forth in the claims encompass all available equivalents of those claims. Embodiments of the invention may be referred to, individually or collectively, herein by the term “invention” merely for convenience and without intending to voluntarily limit the scope of this application to any single invention or inventive concept if more than one is in fact disclosed.

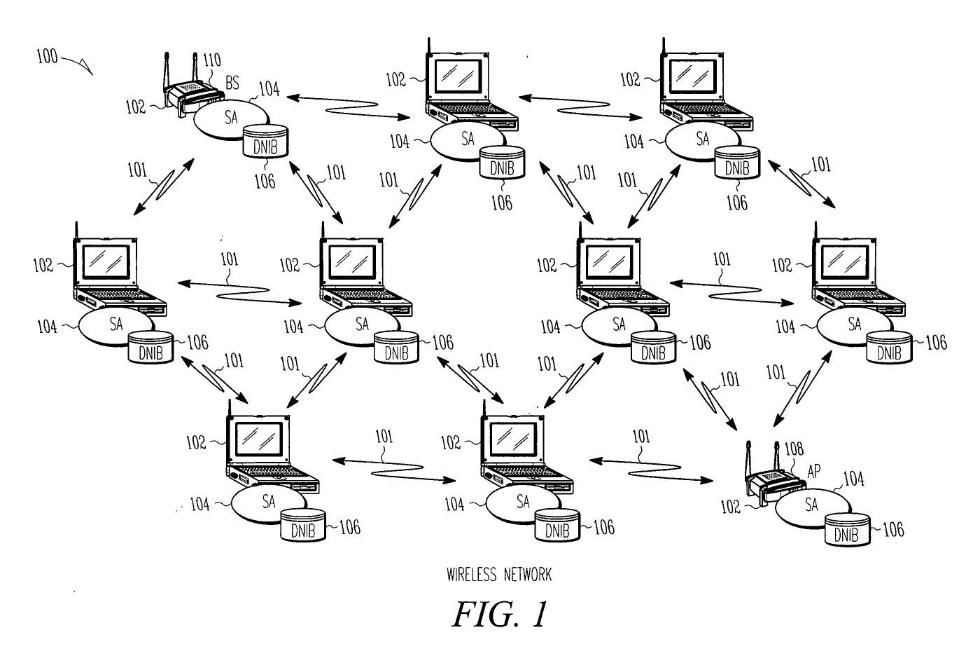

FIG. 1 illustrates a wireless network in accordance with some embodiments of the present invention. Wireless network 100 includes a plurality of wireless communication devices 102 that may operate as nodes of network 100. Wireless communication devices 102 may communicate with each other over wireless links 101. In some embodiments, wireless network 100 may be a peer-to-peer network, and in some other embodiments, wireless network 100 may be an ad-hoc network, although the scope of the invention is not limited in this respect. In some embodiments, wireless network 100 may be a wireless local area network (WLAN) and may include one or more access points (AP) 108, although the scope of the invention is not limited in this respect. In some other embodiments, wireless network 100 may be a WiMax or broadband network and may include one or more base stations (BS) 106, although the scope of the invention is not limited in this respect. Each wireless communication device 102 may represent a node of network 100.

In accordance with some embodiments of the present invention, at least some wireless communication devices 102, including access points 108 and base stations 110, may include a service agent (SA) 104 and a distributed network information base (DNIB) 106. Distributed network information bases (DNIB) 106 may store network information in a distributed fashion. Service agents 104 may communicate network information stored in their associated distributed network information base 106 directly between non-adjacent layers of a protocol stack. In some embodiments, service agents 104 utilize the network information to at least maintain or enhance performance of currently active application-layer applications as network conditions change. In some embodiments, service agents 104 may help optimize multimedia performance as network conditions change and may dynamically respond to changes in link quality, as further discussed below.

In some embodiments, cross-layer optimization techniques are applied to address end-to-end quality-of-service (QoS) as well as to address constraints and issues in network 100 and across the enterprise. In these embodiments, additional system-level feedback and more intelligent adaptation may be provided in the protocol stack at respective nodes in an end-to-end path through network 100. Improving and even optimizing overall end-to-end QoS uses the knowledge and/or state of key elements of network 100 during a communicating session. This knowledge is shared effectively between these nodes through use of service agents 104. In some embodiments, an optimization across network 100 may be responsive to variations in link conditions and/or user mobility constraints in the wireless environment. In some embodiments, current conditions at the media-access control (MAC) layer and the physical (PHY) layer may be propagated directly to the network layer at each node by the node's service agent 104. In some of these embodiments, a joint optimization between the network and MAC layers may be performed in conjunction with network-wide information, to help optimize routing and end-to-end QoS dynamically in network 100.

In some embodiments, network-wide adaptation may be proactively achieved with an exchange of information regarding individual links between two endpoints to assess end-to-end performance in network 100. The PHY-layer conditions on each link in wireless network 100 may dynamically vary due to several factors such as network congestion with other users, interfering signals and noise, and the path loss associated with the link. An optimal path between two endpoints in network 100 may be a function of the quality of each of links 101 on the path between the end points. With dynamically varying constraints in wireless network 100, a statically configured optimal path may soon become a less optimal one. In accordance with some embodiments of the present invention, service agents 104 may proactively establish alternate paths for communication of information to quickly switch to an alternate path. Accordingly, a best alternate path may be provided as network conditions vary over time in network 100.

In some embodiments, distributed network information bases 106 may include query management capability for retrieval of end-system-level or network node-level knowledge or information. Service agents 104 at each node 102 may respond to requests for information from a neighboring node in network 100. Service agents 104 may respond with information available from an associated distributed network information base 106 with content locally available at the node. In some embodiments, service agents 104 may forward the request to one or more neighboring node(s) until end-to-end information between two end points involved in a communication path is obtained. The content in distributed network information bases 106 may include information about a node and recent information about neighboring nodes (e.g., based on the depth—number of hops—of the routing table maintained at the node). In some embodiments, request forwarding by a service agent of a particular node may be done selectively to other nodes that are more likely to be candidates for a communication path between two end points. This selective forwarding may be based on link quality, link utilization, and node-location information, when available. In some embodiments, during request forwarding, a list of visited nodes may also be maintained to help avoid loops. In some embodiments, information gathered during request forwarding may be propagated back to the end points.

In some embodiments, service agents 104 may monitor conditions on links 101 being actively used in the associated node's routing table. Network conditions on active links in an active route may vary due to user mobility or due to changes in link quality or link utilizations. For an active critical weak link on which conditions may be degrading, service agents 104 may propagate information about dynamic variation in network conditions to the nodes on the active route. This information may quickly propagate to the end points on the active route. Application-layer applications operating on the end node may, in this way, proactively manage, in real-time, end-to-end QoS management between endpoints involved in a communication path. In these embodiments, service agents 104 of an end node may modify or change application-layer application operating parameters by directly communicate with the PHY and/or MAC layers, although the scope of the invention is not limited in this respect.

In some embodiments, at least some service agents 104 of nodes in an active route may dynamically reconfigure an alternate route in a sub-network. These service agents 104 may modify and/or update routing tables to reflect a new active end-to-end route. In some embodiments, end-to-end QoS information for the new route may be propagated to the endpoints.

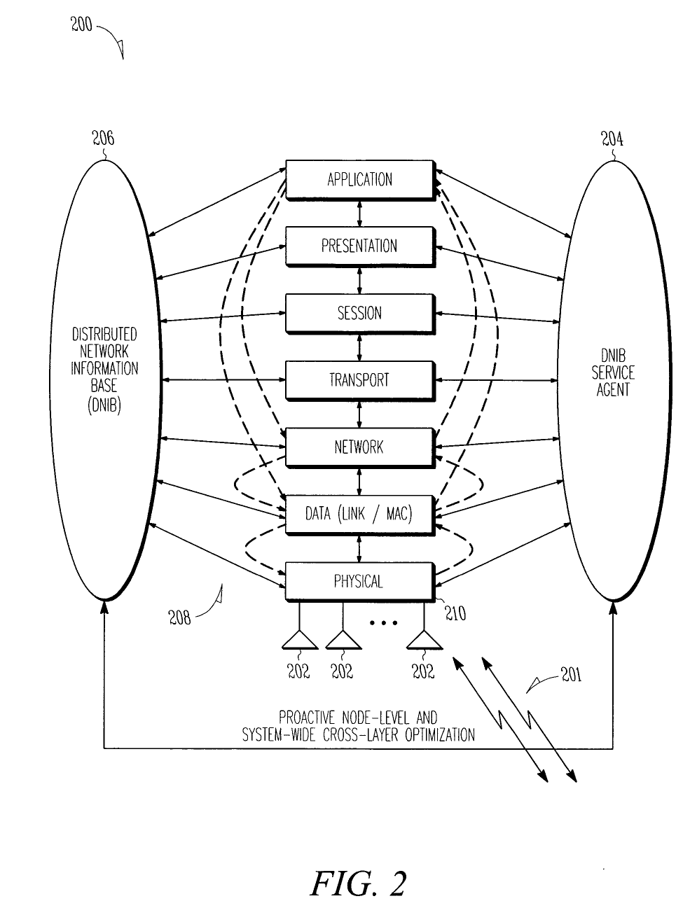

FIG. 2 is a block diagram of a wireless communication device in accordance with some embodiments of the present invention. Wireless communication device 200 may be suitable for use as any one or more of wireless communication devices 102 (FIG. 1), although other configurations may also be suitable for wireless communication devices. In some embodiments, wireless communication device 200 may be referred to as a client device, although the scope of the invention is not limited in this respect. In accordance with some embodiments of the present invention, wireless communication device 200 comprises service agent (SA) 204, distributed network information base (DNIB) 206 and protocol stack 208. In some embodiments, the layers of protocol stack 208 may comprise at least some layers of the open-source interconnection (OSI) protocol stack illustrated, although the scope of the invention is not limited in this respect. In some embodiments, service agent 204 may correspond to service agents 104 (FIG. 1), and distributed network information base 206 may correspond to distributed network information bases 106 (FIG. 1).

In some embodiments, wireless communication device 200 may utilize one or more of antennas 202 to establish and communicate with other wireless devices over wireless links 201. Antennas 202 may comprise one or more directional or omnidirectional antennas, including, for example, dipole antennas, monopole antennas, patch antennas, loop antennas, microstrip antennas or other types of antennas suitable for reception and/or transmission of RF signals over links 201. Links 201 may correspond to one or more of links 101 (FIG. 1).

In some embodiments, distributed network information base 206 may be coupled with service agent 204 by communication path 212, which may be a bus, for communications therebetween. In some embodiments, distributed network information base 206 and service agent 204 may be centralized, while in some other embodiments, they may be implemented in a distributed form. In some embodiments., distributed network information base 206 and service agent 204 may operate on computing devices, while in other embodiments; they may operation on communication devices. In some embodiments, distributed network information base 206 and service agent 204 may support network service agents including quality of service, mobility and routing. In some embodiments, distributed network information base 206 and service agent 204 may support provisioning of policy and management of state. In some embodiments, distributed network information base 206 and service agent 204 may support non-level context and system-wide context.

Although wireless communication device 200 is illustrated as having several separate functional elements, one or more of the functional elements may be combined and may be implemented by combinations of software-configured elements, such as processing elements including digital signal processors (DSPs), and/or other hardware elements. For example, processing elements may comprise one or more microprocessors, DSPs, application specific integrated circuits (ASICs), and combinations of various hardware and logic circuitry for performing at least the functions described herein. In some embodiments, the functional elements of wireless communication device 200 may refer to one or more processes operating on one or more processing elements.

In some embodiments, wireless communication device 200 may transmit multicarrier communication signals, such as orthogonal frequency division multiplexed (e.g., OFDM) communication signals and/or orthogonal frequency division multiple access (e.g., OFDMA) communication signals. In some embodiments, physical layer 210 may transmit and/or receive multicarrier symbols over a multicarrier communication channel. The multicarrier communication channel may be within a predetermined frequency spectrum and may comprise a plurality of orthogonal subcarriers. In some embodiments, the orthogonal subcarriers of a subchannel may be closely spaced OFDM subcarriers, although the scope of the invention is not limited in this respect. To achieve orthogonality between closely spaced subcarriers, in some embodiments, the subcarriers of the multicarrier communication channel may have a null at substantially a center frequency of the other subcarriers of the multicarrier communication channel, although the scope of the invention is not limited in this respect.

In some wireless network embodiments, wireless communication device 200 may communicate with one or more other wireless communication devices over a multicarrier communication channel. In some embodiments, the multicarrier communication channel may comprise either a standard-throughput channel or a high-throughput communication channel. In these embodiments, the standard-throughput channel may comprise one multicarrier channel and the high-throughput channel may comprise a combination of one or more subchannels and one or more spatial channels associated with each multicarrier channel. Spatial channels may be non-orthogonal channels (i.e., not separated in frequency) associated with a particular multicarrier channel in which orthogonality may be achieved through beamforming and/or diversity through the use of two or more of antennas 202. In some of these embodiments that use two or more antennas to communicate, wireless communication device 200 may be referred to as multiple input, multiple output (MIMO) communication device, although the scope of the invention is not limited in this respect.

In accordance with some embodiments, physical layer 210 may symbol-modulate the subcarriers in accordance with one of a plurality of subcarrier modulation levels. The modulation levels may include binary phase shift keying (BPSK), which communicates one bit per symbol, quadrature phase shift keying (QPSK), which communicates two bits per symbol, 8PSK, which communicates three bits per symbol, 16-quadrature amplitude modulation (16-QAM), which communicates four bits per symbol, 32-QAM, which communicates five bits per symbol, 64-QAM, which communicates six bits per symbol, 128-QAM, which communicates seven bits per symbol, and 256-QAM, which communicates eight bits per symbol. Modulation levels with higher data communication rates per subcarrier may also be used. An OFDM symbol, for example, may be viewed as the combination of the symbols modulated on the individual subcarriers of the multicarrier communication channel.

In some embodiments, a multicarrier communication channel may have a bandwidth of approximately 20 MHz and may have up to 48 or more orthogonal data subcarriers having a spacing therebetween of approximately 312.5 kHz, although the scope of the invention is not limited in this respect. In accordance with some embodiments of the present invention, physical layer 110 may includes circuitry to interleave, subcarrier modulate, and transmit OFDM symbols over communication links 101 (FIG. 1).

In some embodiments, the frequency spectrums for a multicarrier communication channel may comprise either a 5 GHz frequency spectrum or a 2.4 GHz frequency spectrum. In these embodiments, the 5 GHz frequency spectrum may include frequencies ranging from approximately 4.9 to 5.9 GHz, and the 2.4 GHz spectrum may include frequencies ranging from approximately 2.3 to 2.5 GHz, although the scope of the invention is not limited in this respect, as other frequency spectrums are also equally suitable.

In some embodiments, wireless communication device 200 may be a personal digital assistant (PDA), a laptop or portable computer with wireless communication capability, a web tablet, a wireless telephone, a wireless headset, a pager, an instant messaging device, a digital camera, an access point, a base station, a wireless interface or other device that may receive and/or transmit information wirelessly. In some embodiments, physical layer 210 may transmit and/or receive RF communications in accordance with specific communication standards, such as the Institute of Electrical and Electronics Engineers (IEEE) standards including IEEE 802.11(a), 802.11(b), 802.11(g/h) and/or 802.11(n) standards for wireless local area networks (WLANs) and/or 802.16 standards for broadband networks such as wireless metropolitan area networks (WMANs), although device 200 may also be suitable to transmit and/or receive communications in accordance with other techniques including the Digital Video Broadcasting Terrestrial (DVB-T) broadcasting standard, and the High performance radio Local Area Network (HiperLAN) standard.

In some embodiments, distributed network information base 206 may store network information service agent 204 may communicate the network information stored in distributed network information base 206 directly between non-adjacent layers of a protocol stack 208. In some embodiments, service agent 204 may utilize the network information to at least attempt to maintain (or even enhance) performance of currently active application-layer applications as network conditions change, although the scope of the invention is not limited in this respect.

In some embodiments, distributed network information base 206 may store network information comprising current link quality of active links. The active links may be associated with one or more active routes, and each active route may be being used by one of the currently active application-layer applications. A currently active application-layer application may, for example, be operating on an application layer of an end node. Distributed-network information base 206 may further store application performance requirements for the active applications and may associate application performance requirements with each of the active routes.

In some embodiments, service agent 204 may respond to requests from neighboring nodes for network information stored in distributed network information base 206.

In some embodiments, service agent 204 may monitor conditions 302 on the active links, and may broadcast link quality information to the neighbor nodes. In these embodiments, service agents of the neighbor nodes may update their own distributed network information base with the broadcasted link quality information. In some embodiments, service agent 204 may broadcast link quality information on a regular basis, although the scope of the invention is not limited in this respect.

In some embodiments, service agent 204 may monitors conditions on the active links of the active routes utilizing its node. When the current link quality conditions of one or more of the active links of an active route falls below a performance threshold for an associated active application-layer application, service agent 204 may identify the active application-layer application associated with the one or more active links (i.e., identifies which active applications are using the affected links), and may broadcast a route configuration message to some or all nodes of the network to initiate route reconfiguration for the associated active applications. In some embodiments, the performance threshold may be related to the application performance requirement for the associated active application.

In some embodiments, service agent 204 may configure, at least in part, an alternate route for the active application-layer applications using the application performance requirements stored in distributed network information base 206 for the associated active application-layer application.

In some embodiments, service agent 204, when configuring an alternate route, may use link quality information received from distributed network information bases of neighbor nodes. In these embodiments, service agent 204, along with service agents of other nodes of the plurality may configure the alternate route. In some embodiments, service agent 204 may reconfigure, at least in part, other active routes by considering bandwidth that becomes available (i.e., released) when the alternate route is configured.

In some embodiments, wireless communication device 200 may include a storage element (illustrated as DNIB 206) to store a portion of the distributed network information base. The storage element may be any electronic storage medium including semiconductor memory types as well as magnetic and or optical media storage types.

In some embodiments, the application-layer application may include a multimedia streaming application in which a packetized video stream is communicated between end-nodes over active links comprising an associated active route. In some embodiments, service agent 204 may receive the application performance requirements of a currently active application-layer application from an end node that is currently running the active application-layer application. In these embodiments, service agent 204 may operates within a node on an active route associated with the active application-layer application.

In some embodiments, physical layer 210 may communicate orthogonal frequency division multiplexed signals with other nodes of the wireless network. The orthogonal frequency division multiplexed signals may comprise a plurality of substantially orthogonal subcarriers within a channel bandwidth. In some embodiments, physical layer 210 may be coupled to two or more antennas 202 for communicating with neighbor nodes of wireless network 100 (FIG. 1) using two or more spatial channels. The spatial channels may use the same subcarriers within the channel bandwidth.

In some embodiments service agent 204 may instruct physical layer 210 of protocol stack 208 to dynamically adapt to changing link conditions. In some embodiments service agent 204 may instruct physical layer 210 of protocol stack 208 to change a modulation level for packets at the physical layer. In some embodiments service agent 204 may instruct physical layer 210 of protocol stack 208 to change a coding scheme for packets at the physical layer. In some embodiments service agent 204 may instruct physical layer 210 of protocol stack 208 to change the number of antennas 202 to use for communicating with other nodes. In some embodiments service agent 204 may instruct physical layer 210 of protocol stack 208 to change a channel bandwidth utilized by at least one of the wireless links (e.g., from a 20 MHz multicarrier channel to a 40 MHz multicarrier channel), although the scope of the invention is not limited in this respect.

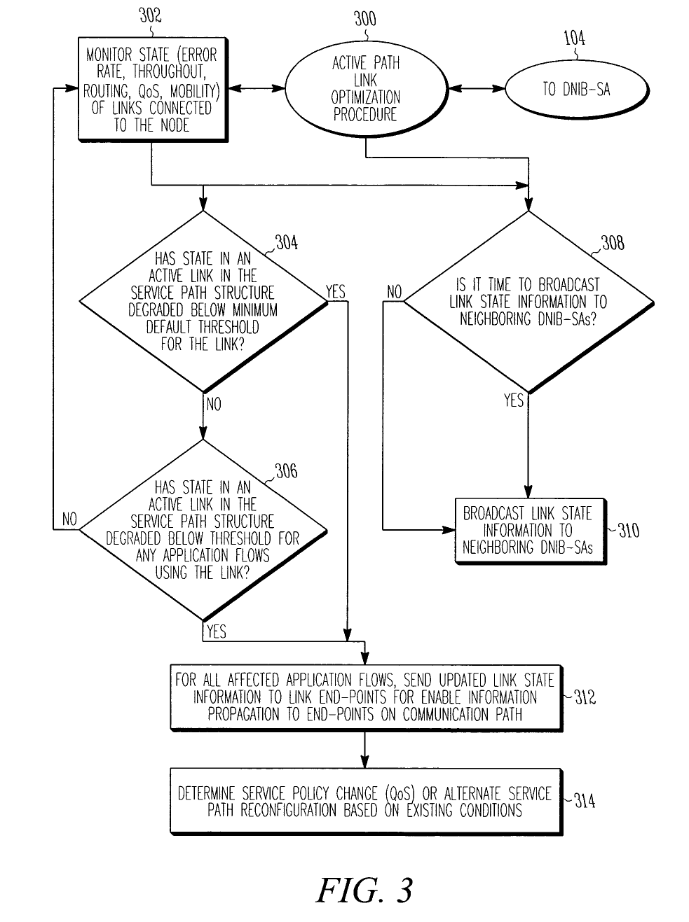

FIG. 3 is a flow chart of a service agent operating procedure in accordance with some embodiments of the present invention. Service agent operating procedure 300 may be performed by one or more of service agents 104 (FIG. 1). In some embodiments, service agent operating procedure 300 may be performed concurrently by most or substantially all service agents 104 (FIG. 1) of network 100 (FIG. 1) as network conditions and network usage changes.

Operation 302 comprises monitoring the quality of links connected to a node. Operation 302 may include monitoring physical-layer conditions of the links such as packet-error-rate (PER), throughput and link utilization. The links may include active links that are used to route packets as part of an active route being used by an active-application layer application of an end node to send packets to another end node.

Operation 304 comprises determining whether the quality of an active link in the node's routing table has degraded below a minimum default threshold for the link. When link quality falls below the minimum default threshold for an active link, operation 312 is performed. If the link quality is not below the minimum default threshold for an active link, operation 306 is performed.

Operation 306 comprises determining whether the quality of an active link in the node's routing table has degraded below a threshold for a currently active application using the link. When link quality falls below the minimum threshold for the application, operation 312 is performed. Otherwise, operation 302 continues to be performed indicating that a link continues to provide acceptable performance.

Operation 312 comprises sending or routing information to end-nodes operating currently active applications that are utilizing routes associated with the links identified in either operation 304 or 306.

Operation 314 comprises determining a service policy change (e.g., a quality-of-service change) or an alternate service path reconfiguration based on existing conditions. In some embodiments, a service policy change decision or alternate service path reconfiguration decision may be done for application flows enabling more optimal link utilization for the existing conditions, although the scope of the invention is not limited in this respect.

In operation 308, the service agent of a node may determine whether it is time to broadcast 310 link quality information to the neighbor nodes, and in operation 310, the service agent may broadcast link quality information to the neighbor nodes. Service agents of neighbor nodes may update their own distributed network information base with the broadcasted link quality information. In some embodiments, service agents may broadcast link quality information on a regular basis, although the scope of the invention is not limited in this respect.

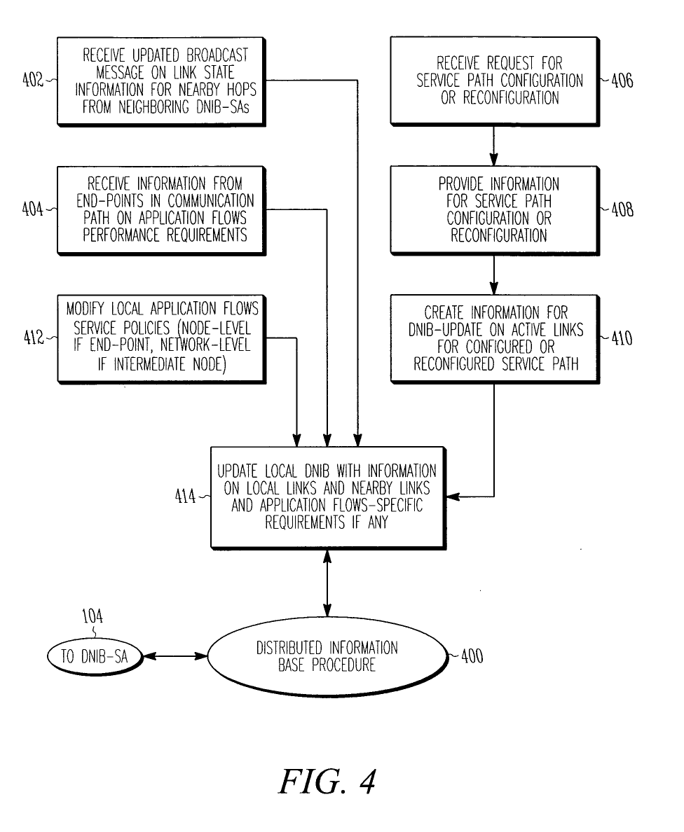

FIG. 4 is a flow chart of a distributed network information base update procedure in accordance with some embodiments of the present invention. Distributed network information base update procedure 400 may be performed by one or more of service agents 104 (FIG. 1). In some embodiments, procedure 400 may be performed concurrently by most or substantially all service agents 104 (FIG. 1) of network 100 (FIG. 1) to maintain network information in their distributed network information bases 106 (FIG. 1).

Operation 402 comprises receiving a message broadcasted from a node that includes updated link quality information for nearby links associated with neighbor nodes. In some embodiments, the link quality information may have been generated during the performance of operation 310 (FIG. 3).

Operation 404 comprises receiving initial or undated information from end-nodes of an active route. The initial or updated information may include application performance requirements. In some embodiments, the updated information may have been generated during the performance of operation 318 (FIG. 3).

Operation 406 comprises receiving a request for route reconfiguration from a node of the network. The request may have been generated by a node performing operation 314 (FIG. 3).

Operation 408 comprises providing information for route reconfiguration to other network nodes in response to the request received in operation 406.

Operation 410 comprises generating information for a node's DNIB to update the information for the active links associated with a newly configured route or a reconfigured route.

Operation 412 comprised modifying local application flows service policies. The local application flows service policies may be modified at node-level when the node is an end-node. The local application flows service policies may be modified at network-level if the node is an intermediate node.

Operation 414 comprises updating a node's distributed network information base with the information received in operation 402, operation 404, operation 410 and/or operation 412. The information may include information about local links as well as application-specific requirements, although the scope of the invention is not limited in this respect.

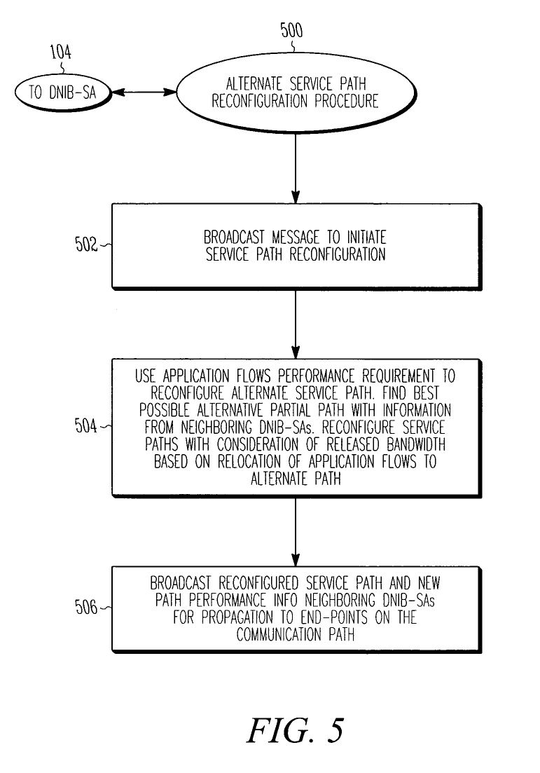

FIG. 5 is a flow chart of an alternate service path reconfiguration procedure in accordance with some embodiments of the present invention. Operation 502 comprises broadcasting a message to nodes to initiate route reconfiguration for the affected routes. Operation 504 comprises using application performance requirements of the one or more currently active applications to reconfigure an alternate route. Operation 504 may be performed jointly with more than one service agent of nodes of the network. In some embodiments, possible alternate routes and/or partial routes are identified with information from neighboring DNIBs. In some embodiments, unaffected routes may be reconfigured considering the bandwidth that becomes available when an active route is reconfigured to use to other links.

Operation 506 comprises broadcasting reconfigured routes to neighboring nodes for propagation to the end nodes operating the currently active applications associated with the reconfigured routes. In some embodiments, operation 318 may also include broadcasting performance information for the reconfigured routes for propagation to the end nodes, although the scope of the invention is not limited in this respect.

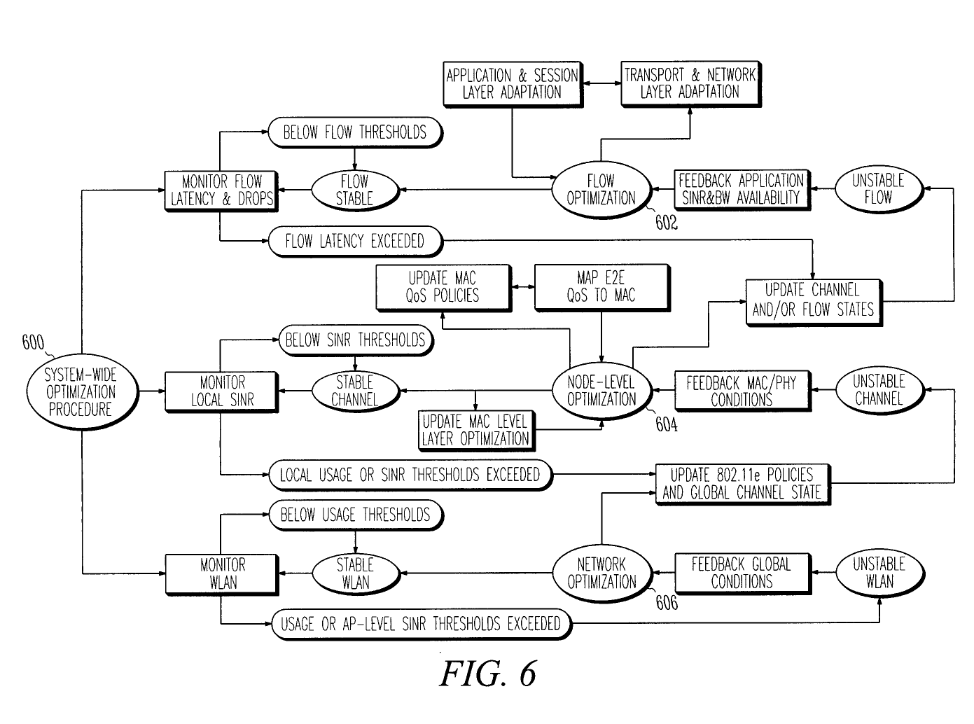

FIG. 6 is a flow chart of a system-wide optimization procedure in accordance with some embodiments of the present invention. System-wide optimization procedure 600 may be performed in a distributed fashion by one or more nodes of network 100 (FIG. 1). The system wide optimization may be a cross-layer optimization, and may operation at very-low time scales to help enable a fast and proactive adaptation to changing conditions. System-wide optimization procedure 600 includes flow optimization portion 602, node-level optimization, and network-level optimization portion 606. Information from procedure 600 may be provided to DNIB 106 (FIG. 1) and service agents 104 (FIG. 1) of one or more other nodes 102 (FIG. 1) as shown.

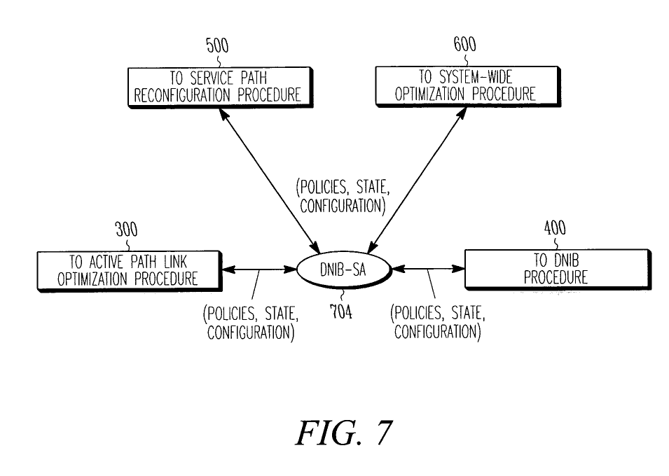

FIG. 7 illustrates the operations of a distributed network information base (DNIB) service agent (SA) in accordance with some embodiments of the present invention. In FIG. 7, distributed network information base (DNIB) service agent (SA) 704 may correspond to any one or more of DNIBs 106 (FIG. 1) including DNIB 204 (FIG. 2). As illustrated, DNIB SA 704 may perform any one or more of procedures 300, 400, 500 and 600.

Although the individual operations of procedures 300, 400, 500 and 600 are illustrated and described as separate operations, one or more of the individual operations may be performed concurrently, and nothing requires that the operations be performed in the order illustrated.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, computing device includes one or more processing elements coupled with computer-readable memory that may be volatile or non-volatile memory or a combination thereof.

Embodiments of the invention may be implemented in one or a combination of hardware, firmware and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus the following claims are hereby incorporated into the detailed description, with each claim standing on its own as a separate preferred embodiment.

What is claimed is:

1. A wireless communication device comprising:
a distributed network information base to store network information; and
a service agent to communicate the network information stored in the distributed network information base directly between non-adjacent layers of a protocol stack,
wherein the service agent is to utilize the network information to at least attempt to maintain performance of currently active application-layer applications as network conditions change.

2. The device of claim 1 wherein the wireless communication device is a node that operates as a node in a wireless network of a plurality of nodes coupled by wireless links, and
wherein the distributed network information base stores network information comprising current link quality of active links,
wherein the active links are associated with one or more active routes, each active route being used by one of the currently active application-layer applications, and
wherein the distributed network information base further stores application performance requirements for the active applications and associates the application performance requirements with the active routes.

3. The device of claim 2 wherein the service agent is adapted to respond to requests from neighboring nodes for network information stored in the distributed network information base.

4. The device of claim 2 wherein the service agent is adapted to monitor conditions on the active links, and
the service agent is adapted to broadcast link quality information to the neighbor nodes,
wherein service agents of the neighbor nodes are adapted to update their own distributed network information base with the broadcasted link quality information.

5. The device of claim 2 wherein the service agent monitors conditions on the active links, and
wherein when the current link quality conditions of one or more of the active links of an active route falls below a performance threshold for an associated active application-layer application, the service agent is to:
identify the active application-layer application associated with the one or more active links; and
broadcast a route configuration message to initiate route reconfiguration for the associated active applications.

6. The device of claim 5 wherein the service agent is adapted to configure, at least in part, an alternate route for the active application-layer application using the application performance requirements stored in the distributed network information base for the associated active application-layer application.

7. The device of claim 6 wherein the service agent, when configuring an alternate route, uses link quality information received from distributed network information bases of neighbor nodes, and
wherein the service agent, along with service agents of other nodes of the plurality, is to configure the alternate route.

8. The device of claim 6 wherein the service agent is to reconfigure, at least in part, other active routes by considering bandwidth that becomes available when the alternate route is configured.

9. The device of claim 1 further comprising a storage element to store a portion of the distributed network information base.

10. The device of claim I wherein the application-layer application comprises a multimedia streaming application in which a packetized video stream is communicated between end-nodes over active links comprising an associated active route.

11. The device of claim 2 wherein the service agent is adapted to receive the application performance requirements of a currently active application-layer application from an end node that is currently running the active application-layer application,
wherein the service agent operates within a node on an active route associated with the active application-layer application.

12. The device of claim 2 wherein one of the layers is a physical layer adapted to communicate orthogonal frequency division multiplexed signals with other nodes of the wireless network, the orthogonal frequency division multiplexed signals comprising a plurality of substantially orthogonal subcarriers within a channel bandwidth.

13. The device of claim 12 wherein the physical layer is coupled to two or more antennas for communicating with neighbor nodes of the wireless network using two or more spatial channels using the plurality of substantially orthogonal subcarriers within the channel bandwidth.

14. The device of claim 13 wherein the service agent is to instruct the physical layer of the protocol stack to dynamically adapt to changing link conditions, the physical layer is instructed change at least one of a modulation level for packets at the physical layer, a coding scheme for packets at the physical layer, a number of the antennas to use for communicating with other nodes, and a channel bandwidth utilized by at least one of the wireless links.

15. In a wireless network, a method of adapting to changes in network conditions comprising:
communicating network information stored in a distributed network information base directly between non-adjacent layers of a protocol stack; and
utilizing the network information to at least attempt to maintain performance of currently active application-layer applications as network conditions change.

16. The method of claim 15 further comprising:
storing network information in the distributed network information base, the network information comprising current link quality of active links,
associating active links with one or more active routes, each active route being used by one of the currently active application-layer applications; and
storing application performance requirements for the active applications in the distributed network information base and associating the application performance requirements with the active routes.

17. The method of claim 16 further comprising responding to requests from neighboring nodes for network information stored in the distributed network information base.

18. The method of claim 16 further comprising:
monitoring conditions on active links; and
broadcasting link quality information to the neighbor nodes,
wherein service agents of the neighbor nodes are to update their own distributed network information base with the broadcasted link quality information.

19. The method of claim 16 further comprising monitoring conditions on the active links; and
wherein when current link quality conditions of one or more of the active links of an active route falls below a performance threshold for an associated active application-layer application, the method comprises:
identifying the active application-layer application associated with the one or more active links; and
broadcasting a route configuration message to initiate route reconfiguration for the associated active applications.

20. The method of claim 19 further comprising configuring, at least in part, an alternate route for the active application-layer applications using the application performance requirements stored in the distributed network information base for the associated active application-layer application.

21. The method of claim 20 wherein configuring comprises using link quality information received from distributed network information bases of neighbor nodes,
wherein service agents of nodes of a plurality of nodes are to configure the alternate route.

22. The method of claim 20 further comprising reconfiguring, at least in part, other active routes, by considering bandwidth that becomes available when the alternate route is configured.

23. The method of claim 15 further comprising storing a portion of the distributed network information base in a storage medium within a network node

24. The method of claim 15 wherein the application-layer application comprises a multimedia streaming application, wherein the method further comprises communicating a packetized video stream between end-nodes over active links comprising an associated active route.

25. The method of claim 16 further comprising receiving the application performance requirements of a currently active application-layer application from an end node that is currently running the active application-layer application.

26. The method of claim 16 further comprising communicating orthogonal frequency division multiplexed signals with nodes of the wireless network, the orthogonal frequency division multiplexed signals comprising a plurality of substantially orthogonal subcarriers within a channel bandwidth.

27. The method of claim 26 wherein the communicating comprises communicating with two or more antennas with neighbor nodes of the wireless network using two or more spatial channels using the plurality of substantially orthogonal subcarriers within the channel bandwidth.

28. The method of claim 27 further comprising instructing a physical layer of a protocol stack to dynamically adapt to changing link conditions, the physical layer to change at least one of a modulation level for packets at the physical layer, a coding scheme for packets at the physical layer, a number of the antennas to use for communicating with other nodes, and a channel bandwidth utilized by at least one of the wireless links.

29. A network comprising:
a plurality of network nodes that operate as peers and communicate over wireless links therebetween, wherein each node includes a distributed network information base to store network information, and a service agent to communicate the network information stored in the distributed network information base directly between non-adjacent layers of a protocol stack,
wherein the service agent is to utilize the network information to at least attempt to maintain performance of currently active application-layer applications as network conditions change.

30. The network of claim 29 wherein
wherein the wireless communication device is a node that operates as a node in a wireless network of a plurality of nodes coupled by wireless links, and
wherein the distributed network information base stores network information comprising current link quality of active links,
wherein the active links are associated with one or more active routes, each active route being used by one of the currently active application-layer applications, and
wherein the distributed network information base further stores application performance requirements for the active applications and associates the application performance requirements with the active routes.

31. The network of claim 30 wherein the service agent is adapted to respond to requests from neighboring nodes for network information stored in the distributed network information base.

32. The network of claim 30 wherein the service agent is adapted to monitor conditions on the active links, and
the service agent is adapted to broadcast link quality information to the neighbor nodes,
wherein service agents of the neighbor nodes are adapted to update their own distributed network information base with the broadcasted link quality information.

33. The network of claim 32 wherein the service agent monitors conditions on the active links, and
wherein when the current link quality conditions of one or more of the active links of an active route falls below a performance threshold for an associated active application-layer application, the service agent is to:
identify the active application-layer application associated with the one or more active links; and
broadcast a route configuration message to initiate route reconfiguration for the associated active applications.

34. A system comprising:
one or more substantially omnidirectional antennas;
a wireless communication device to communicate with other wireless communication devices with the one or more antennas, the wireless communication device comprising:
a distributed network information base to store network information; and
a service agent to communicate the network information stored in the distributed network information base directly between non-adjacent layers of a protocol stack,
wherein the service agent is to utilize the network information to at least attempt to maintain performance of currently active application-layer applications as network conditions change.

35. The system of claim 34 wherein the wireless communication device is a node that operates as a node in a wireless network of a plurality of nodes coupled by wireless links, and
wherein the distributed network information base stores network information comprising current link quality of active links,
wherein the active links are associated with one or more active routes, each active route being used by one of the currently active application-layer applications, and
wherein the distributed network information base further stores application performance requirements for the active applications and associates the application performance requirements with the active routes.

36. The system of claim 35 wherein
wherein the service agent is adapted to monitor conditions on the active links, and
the service agent is adapted to broadcast link quality information to the neighbor nodes,
wherein service agents of the neighbor nodes are adapted to update their own distributed network information base with the broadcasted link quality information,
wherein the service agent monitors conditions on the active links, and
wherein when the current link quality conditions of one or more of the active links of an active route falls below a performance threshold for an associated active application-layer application, the service agent is to:
identify the active application-layer application associated with the one or more active links; and
broadcast a route configuration message to initiate route reconfiguration for the associated active applications.

37. A machine-accessible medium that provides instructions, which when accessed, cause a machine to perform operations comprising:
communicating network information stored in a distributed network information base directly between non-adjacent layers of a protocol stack; and
utilizing the network information to at least attempt to maintain performance of currently active application-layer applications as network conditions change.

38. The machine-accessible medium of claim 37 wherein the instructions, when further accessed cause the machine to perform operations further comprising:
storing network information in the distributed network information base, the network information comprising current link quality of active links,
associating active links with one or more active routes, each active route being used by one of the currently active application-layer applications; and
storing application performance requirements for the active applications in the distributed network information base and associating the application performance requirements with the active routes.

39. The machine-accessible medium of claim 38 wherein the instructions, when further accessed cause the machine to perform operations further comprising responding to requests from neighboring nodes for network information stored in the distributed network information base.

40. The machine-accessible medium of claim 38 wherein the instructions, when further accessed cause the machine to perform operations further comprising:
monitoring conditions on active links; and
broadcasting link quality information to the neighbor nodes,
wherein service agents of the neighbor nodes are to update their own distributed network information base with the broadcasted link quality information.

41. The machine-accessible medium of claim 38 wherein the instructions, when further accessed cause the machine to perform operations further comprising monitoring conditions on the active links; and
wherein when current link quality conditions of one or more of the active links of an active route falls below a performance threshold for an associated active application-layer application, the method comprises:
identifying the active application-layer application associated with the one or more active links; and
broadcasting a route configuration message to initiate route reconfiguration for the associated active applications.

42. A service agent to communicate network information stored in a distributed network information base directly between non-adjacent layers of a protocol stack and to utilize the network information to at least attempt to maintain performance of currently active application-layer applications as network conditions change.

43. The service agent of claim 42 wherein the service agent operates as part of a node in a wireless network of a plurality of nodes coupled by wireless links, and
wherein the distributed network information base stores network information comprising current link quality of active links,
wherein the active links are associated with one or more active routes, each active route being used by one of the currently active application-layer applications, and
wherein the distributed network information base further stores application performance requirements for the active applications and associates the application performance requirements with the active routes.

44. The service agent of claim 43 wherein the service agent is adapted to respond to requests from neighboring nodes for network information stored in the distributed network information base,
wherein the service agent is adapted to monitor conditions on the active links, and
the service agent is adapted to broadcast link quality information to the neighbor nodes,
wherein service agents of the neighbor nodes are adapted to update their own distributed network information base with the broadcasted link quality information.

45. The device of claim 44 wherein the service agent monitors conditions on the active links, and
wherein when the current link quality conditions of one or more of the active links of an active route falls below a performance threshold for an associated active application-layer application, the service agent is to:
identify the active application-layer application associated with the one or more active links; and
broadcast a route configuration message to initiate route reconfiguration for the associated active applications.
